(19) United States
(12) Patent Application Publication
(10) Pub. No.: US 2010/0053232 A1
(43) Pub. Date: Mar. 4, 2010

(54) Image Optimization Method for Liquid Crystal Display Device

(75) Inventors: Shih-Chian Liu, Hsin-Chu (TW); Chung-Lin Fu, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 12/533,549

(22) Filed: Jul. 31, 2009

(30) Foreign Application Priority Data
Sep. 1, 2008 (TW) 97133485

(51) Int. Cl. G09G 5/10

(52) U.S. Cl. 345/690; 345/88

(57) ABSTRACT

The present invention provides an image optimization method for performing data update on pixel units in the pixel matrix of the liquid crystal displays. The pixel matrix includes at least a first row and a second row, wherein the first row and the second row respectively include a plurality of pixel units. In one frame period, the image optimization method performs data update respectively on pixel units of the first row and the second row according to a first sequence. In another frame period, the image optimization method performs data update respectively on pixel units of the first row and the second row according to a second sequence.

### BACKGROUND OF THE INVENTION

1. Field of the Invention

This invention relates to an image optimization method of a display device and more specifically to an image optimization method of a liquid crystal display device.

2. Description of the Prior Art

In recent years, liquid crystal displays have become the mainstream in various types of display devices. Liquid crystal displays are extensively used in electronic products such as home televisions, monitors of personal computers and laptop computers, mobile phones, and digital cameras. FIG. 1 is a schematic view of a pixel unit in a conventional liquid crystal display and FIG. 2 is a waveform diagram illustrating the switching timing of elements in the pixel unit and the voltage of the storage capacitor of the pixel unit. As shown in FIG. 1 and FIG. 2, a plurality of data lines (not illustrated) are connected to a multiplexer (not illustrated) which is in turn connected to a video line. Please refer to FIG. 1 and FIG. 2, for a row period 30, the scan line (scan001) switches on the pixel switch 112 of the pixel unit 110. Furthermore, the multiplexer will also switch on the data accepting switch 111 for a first time slot 31. Then, the video line starts updating the data stored in the pixel unit 110 by charging the storage capacitor 113. As shown in FIG. 2, the voltage (Vpx1) of the storage capacitor 113 increases according to an exponential function. However, although the data accepting switch 111 is switched off after the first time slot 31, the storage capacitor 113 is still being charged by the parasitic capacitance within the circuit until the end of the sequence switching period 30 or the voltage Vpx1 of the storage capacitor 113 equal to that of the parasitic capacitor.

As shown in FIG. 2, the increase in voltage (Vpx1) across the storage capacitor 113 follows the exponential function; thus the longer the row period 30, the closer the voltage (Vpx1) of the storage capacitor 113 approximates to the voltage of parasitic capacitance. Thus the length of the row period 30 determines the voltage (Vpx1) of the storage capacitor 113. It can be seen that the timing for switching on the data accepting switch 111 also determines the timing that the voltage (Vpx1) of the storage capacitor 113 starts increasing. Furthermore, other pixel units are also connected to the scan line (scan001) and storage capacitors of the pixel units each has a corresponding data accepting switch, e.g. SW2 or SWm and a corresponding voltage, e.g. Vpx2 or Vpxm. As shown in FIG. 2, the data accepting switch activated earlier (SW1, SW2 or SWm) will allow the corresponding storage capacitor to be charged earlier. On the other hand, if any particular data accepting switch is activated later, its corresponding storage capacitor will stand a chance of not being properly charged. Furthermore, the instability of the thin-film transistor in the pixel unit will also impact on the efficiency in charging the storage capacitor. As such, gray level images will occur in the liquid crystal display and in turn degrade the overall display quality and reduce the reliability of the liquid crystal displays.

### SUMMARY OF THE INVENTION

It is an object of the present invention to provide an image optimization method for performing gamma correction on the liquid crystal display.

It is another object of the present invention to provide an image optimization method for simplifying integrated circuits of the liquid crystal device.

A pixel matrix of the liquid crystal display includes a pixel row set including at least a first row, a second row, and a third row. The first, second, and third rows each has a plurality of pixel units. Each pixel unit has a corresponding representable color. The above-mentioned color includes red, green, or blue, but is not limited thereto. In different embodiments, the pixel units can respectively have other corresponding colors such as white, orange, purple, or other suitable colors. Furthermore, the pixel matrix includes a plurality of data accepting switches and each data accepting switch is electrically connected to one pixel unit respectively of the first row, the second row, and the third row.

The image optimization method of the present invention includes performing data update sequentially on the pixel units of the pixel row set within a frame period, wherein the frame period is further divided into a plurality of time slots. The frame period includes a first row period and a second row period. The first row period is the time period during which the pixel units in the first row are activated for data update. Similarly, the second row period is the period of time during which the pixel units in the second row are activated for data update. The first row period and the second row period can be divided into a plurality of activation time slots. The image optimization method of the present invention activates the pixel units for each activation time slot according to a sequence to perform data update on the pixel units by charging the storage capacitors of the pixel units. The image optimization method can perform data update on pixel units for every row of the pixel matrix according to a sequence within the frame period; in other embodiment, the image optimization method can perform data update on pixel units of every row of the pixel matrix according to different sequences within the frame period.

### BRIEF DESCRIPTION OF THE DRAWINGS

FIG. 1 is a schematic view illustrating a pixel unit in a conventional liquid crystal display device;

FIG. 2 illustrates the activation time slots of data accepting switches and the voltage of the corresponding storage capacitor of prior art;

FIG. 3 is a schematic view of a pixel matrix of a liquid crystal display device;

FIG. 4A is a waveform diagram illustrating a frame period and the row periods, wherein the frame period is divided into a plurality of row periods;

FIG. 4B illustrates the first row period and the second row period, wherein the sequence of activating the data accepting switches is shifted in a left rotation manner;

FIG. 5 illustrates another embodiment of the first row period and the second row period, wherein the sequence of activating the data accepting switches is shifted in a right rotation manner;

FIG. 6 illustrates another embodiment of the first row period and the second row period, wherein the activation time slots of the first group period, the second group period and the third group period are shifted in a right rotation manner;

FIG. 7 illustrates a modified embodiment of the embodiment illustrated in FIG. 6, wherein the activation time slots of the first group period, the second group period and the third group period are shifted in a right rotation manner;

FIG. 8A is a flow chart of an image optimization method of the liquid crystal display device of the present invention;

FIG. 8B illustrates a modified embodiment of the image optimization method illustrated in FIG. 8A;

FIG. 9 illustrates yet another modified embodiment of the image optimization method illustrated in FIG. 8A; and

FIG. 10 illustrates another variation embodiment of the image optimization method illustrated in FIG. 8A.

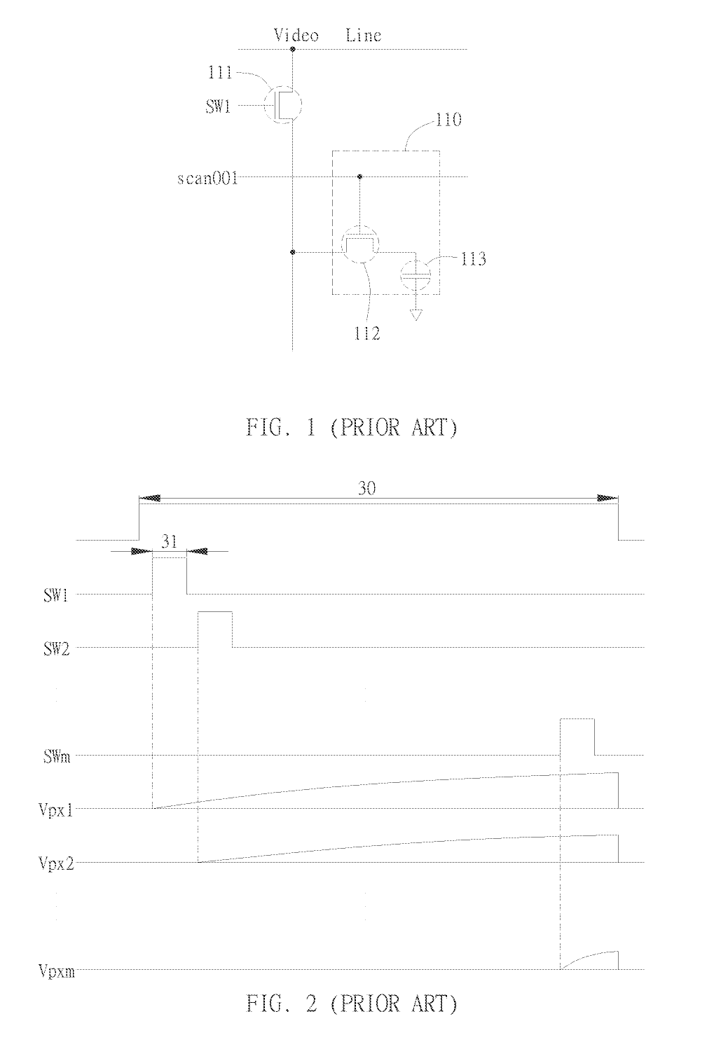

### DETAILED DESCRIPTION OF THE PREFERRED EMBODIMENT

The present invention provides an image optimization method for performing data update sequentially on each pixel unit in a liquid crystal display device within a time period. The image optimization method of the present invention is preferably performed on thin-film transistor liquid crystal displays (TFT-LCDs), but is not limited thereto. The image optimization method of the present invention can be used to perform data update on pixel units of other types of display devices.

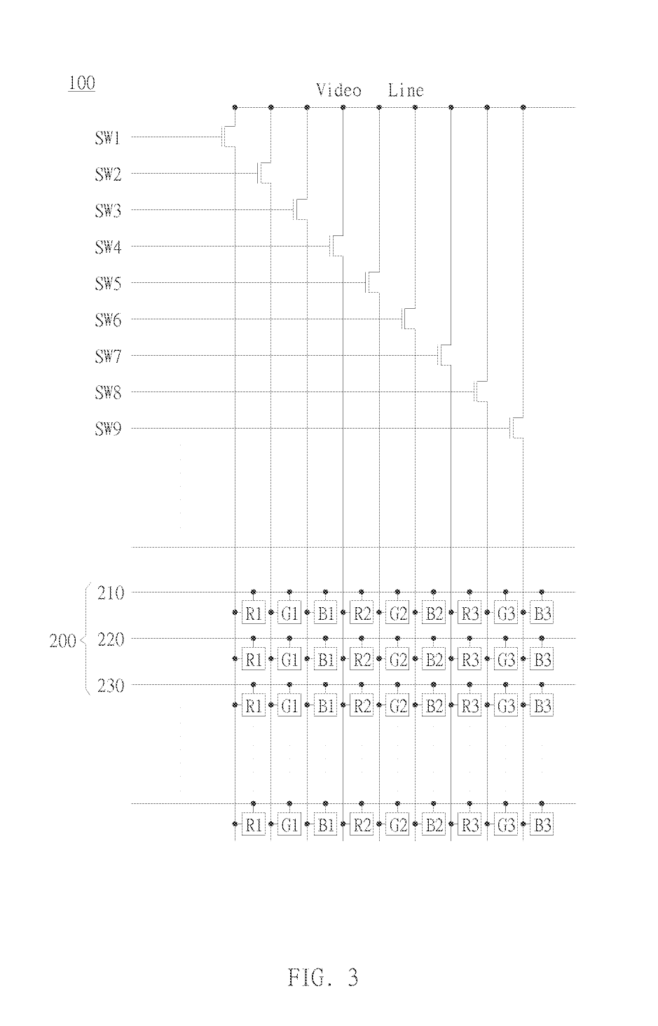

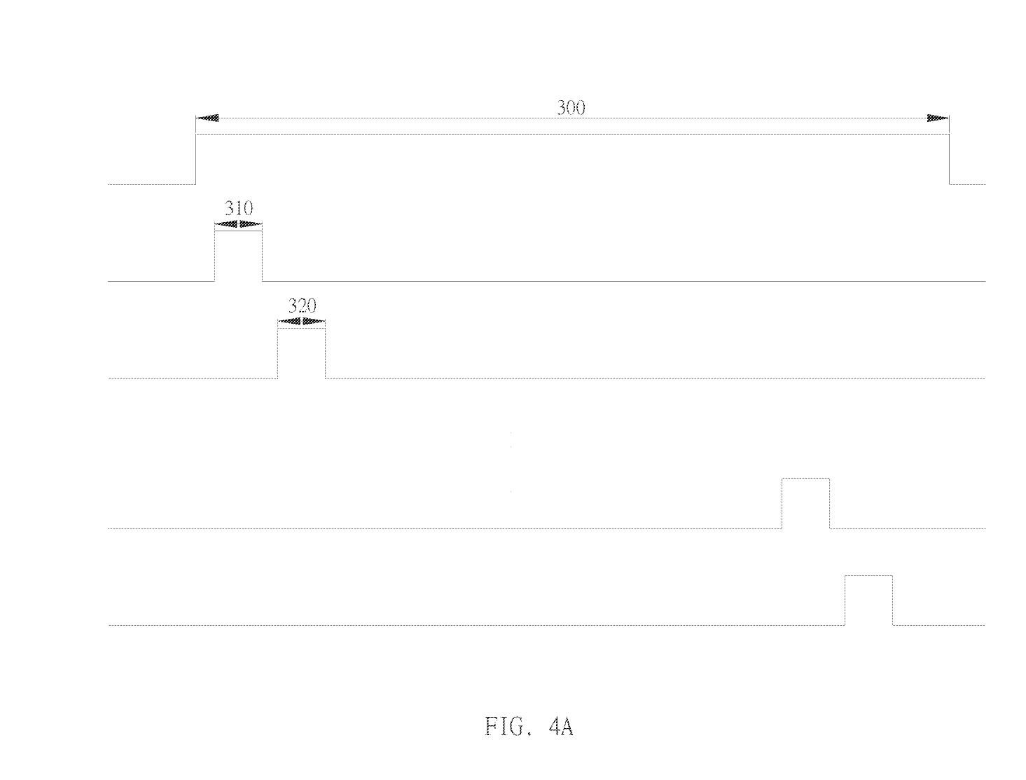

FIG. 3 is a schematic view of a pixel matrix 100 in a liquid crystal display device. As shown in FIG. 3, the pixel matrix 100 includes a pixel row set 200, wherein the pixel row set 200 includes a first row 210, a second row 220, and a third row 230. The first row 210, the second row 220, and the third row 230 respectively have a plurality of pixel units, R1, R2, R3, G1, G2, G3, B1, B2, and B3. In the present embodiment, the number of rows included in the pixel row set 200 depends on the resolution of the liquid crystal display device. Furthermore, each pixel unit has a corresponding representable color. The above-mentioned color includes red, green, or blue, but is not limited thereto. In different embodiments, the pixel unit can respectively have other corresponding colors such as white, orange, purple, or other suitable colors.

In the embodiment illustrated in FIG. 3, the pixel units R1, R2, and R3 correspond to red; the pixel units G1, G2, and G3 correspond to green and the pixel units B1, B2, and B3 correspond to blue. Furthermore, as shown in FIG. 3, the pixel units of the first row 210 can be simultaneously activated for data updating. In other words, the pixel units can be simultaneously activated to charge or data updating storage capacitors (not illustrated) thereof. Furthermore, the pixel matrix 100 includes a plurality of data accepting switches, SW1, SW2, SW3, SW4, SW5, SW6, SW7, SW8, and SW9, wherein each data accepting switch has a corresponding code. In the present embodiment, pixel units having the same code are electrically connected to the same data accepting switch. For instance, the pixel units R1 of the first row 210, the second row 220, and the third row 230 are electrically connected to the data accepting switch SW1.

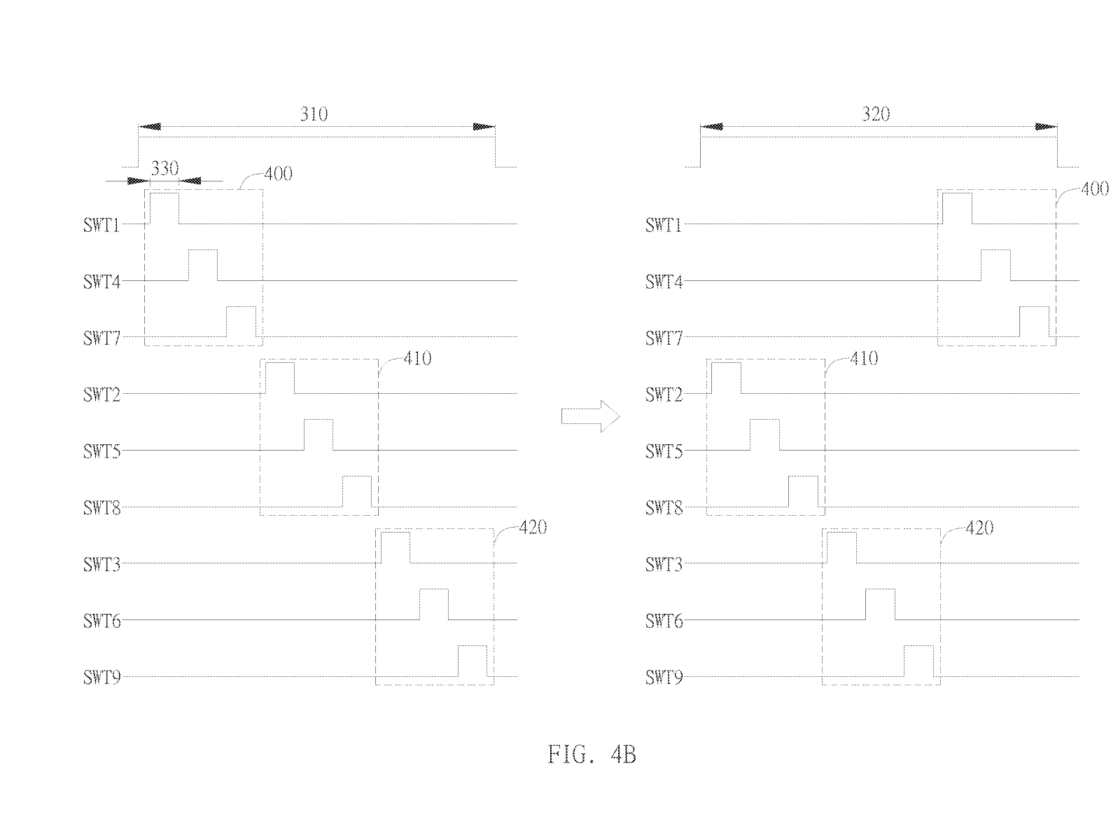

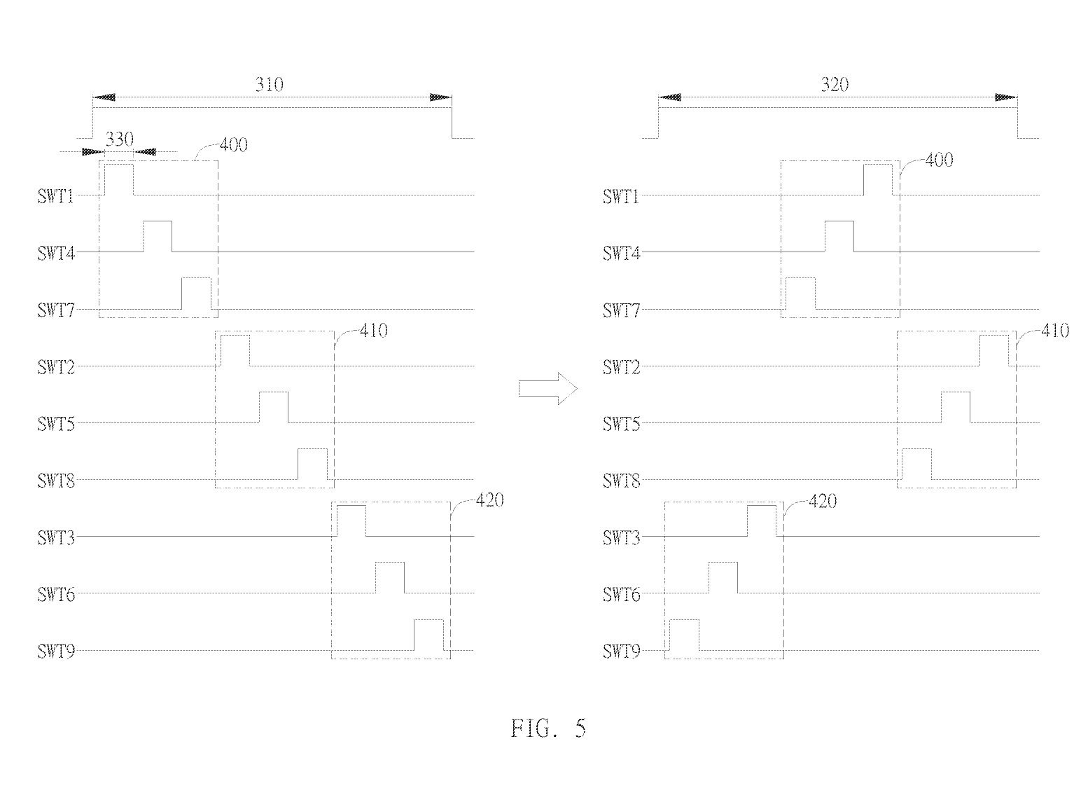

FIG. 4A is a schematic view of a frame period 300. The frame period 300 of the present embodiment represents the display duration of a single frame, wherein the frame period 300 includes a first row period 310 and a second row period 320. The first row period 310 and the second row period 320 are the durations that the pixel units in the first row 210 and the second row 220 are activated, respectively. The length of the first row period 310 and that of the second row period 320 are preferably equal, but not limited thereto. Furthermore, in the embodiment illustrated in FIG. 4A, the frame period 300 includes a plurality of time slots and the amount of time slots preferably correspond to the number of pixel rows in the pixel matrix. Thus the image optimization method of the present invention switches on pixel units in the pixel rows and then updates the data stored in the pixel units in order to display a full frame.

As shown in FIG. 3 and in FIG. 4B, the first row period 310 is divided into a plurality of activation time slots SWT1, SWT2, SWT3, SWT4, SWT5, SWT6, SWT7, SWT8, and SWT9. In the present embodiment, the activation time slots SWT1, SWT2, SWT3, SWT4, SWT5, SWT6, SWT7, SWT8, and SWT9 correspond to data accepting switches SW1, SW2, SW3, SW4, SW5, SW6, SW7, SW8, and SW9, respectively. Each data accepting switch is activated during the corresponding activation time slot for the corresponding pixel unit to receive data. Afterward the video line will start charging the pixel units which correspond to the data accepting switch. In the embodiment illustrated in FIG. 3 and FIG. 4B, the data accepting switches SW1, SW2, SW3, SW4, SW5, SW6, SW7, SW8, and SW9 are respectively activated during the corresponding activation time slots. For instance, the data accepting switch SW1 is activated during the activation time slot SWT1 and the data accepting switch SW4 is activated during the activation time slot SWT4. Similarly, the second row period 320 is divided into a plurality of activation time slots, SWT1, SWT2, SWT3, SWT4, SWT5, SWT6, SWT7, SWT8, and SWT9 correspond to data accepting switches SW1, SW2, SW3, SW4, SW5, SW6, SW7, SW8, and SW9, respectively.

Please refer to FIG. 3 and FIG. 4B, pixel units corresponding to the same color and in the same pixel row can be grouped into individual color groups such as a red group, a green group, or a blue group. In the present embodiment, the first row 210, the second row 220, and the third row 230 can each include a red group, a green group, and a blue group, but are not limited thereto, and can further include a white group or other color groups. In the present embodiment, data accepting switches corresponding to pixel units of the same color group are sequentially activated in the corresponding activation time slots. As shown in FIG. 4B, during the first group period 400 of the first row period 310, pixel units R1, R2, and R3 corresponding to red in the first row 210 are activated respectively in the corresponding activation time slots SWT1, SWT4, and SWT7. During the second group period 410, pixel units G1, G2, and G3 corresponding to green in the first row 210 are activated respectively in the corresponding activation time slots SWT2, SWT5, and SWT8. Similarly, pixel units B1, B2, and B3 corresponding to blue in the first row 210 are activated respectively in the corresponding activation time slots SWT3, SWT6, and SWT9

Furthermore, as shown in FIG. 3 and FIG. 4B, in the second row period 320, the order of the time slots for activating the data accepting switches SWT1, SWT2, SWT3, SWT4, SWT5, SWT6, SWT7, SWT8, and SWT9 is different from that in the first row period 310. The order of the first group period 400, the second group period 410, and the third group period 420 during the second row period 320 are obtained by shifting relative time slots of the first group period 400, the second group period 410, and the third group period 420 in the first row period 310 in a left rotation manner.

In the embodiment illustrated in FIG. 5, the order of the first group period 400, the second group period 410, and the third group period 420 during the first row period 310 is identical to those illustrated in FIG. 4B. However, in the embodiment illustrated in FIG. 5, the order of the first group period 400, the second group period 410, and the third group period 420 during the second row period 320 are obtained by shifting the relative time slots of the first group period 400, the second group period 410, and the third group period 420 in the first row period 310 in a right rotation manner.

Furthermore, as shown in FIG. 5, the order of the activation time slots SWT1, SWT4, and SWT7 in the first group period 400 of the second row period 320 is an inverted version of that of the activation time slots SWT1, SWT4, and SWT7 in the first group period 400 of the first row period 310. Similarly, the order of the activation time slots SWT2, SWT5, and SWT8 in the second group period 410 of the second row period 320 is also an inverted version of that of the activation time slots SWT2, SWT5 and SWT8 in the second group period 410 of the first row period 310. Similarly, the same relationship occurs between activation time slots in the third group period 420 of the second row period 320 and those in the third group period 420 of the first row period 310.

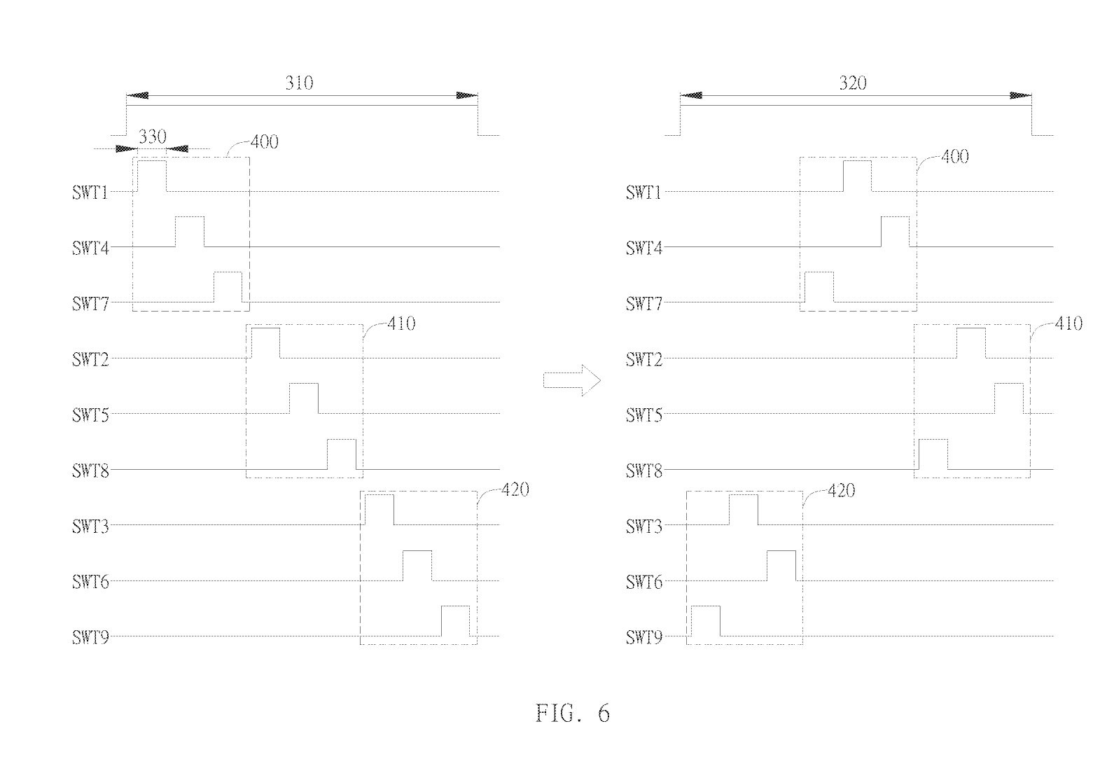

As shown in FIG. 6, the order of the first group period 400, the second group period 410, and the third group period 420 in the first row period 310 is identical to that illustrated in FIG. 4B. In the present embodiment, the order of the first group period 400, the second group period 410, and the third group period 420 in the second row period 320 is obtained by shifting the first group period 400, the second group period 410, and the third group period 420 in a right rotation manner. However, the order of the activation time slots SWT1, SWT4, and SWT7 in the first group period 400 of the second row period 320 is obtained by shifting the activation time slots SWT1, SWT4, and SWT7 in the first group period 400 of the first row period 310 in a right rotation manner. Similarly, the order of the activation time slots SWT2, SWT5, and SWT8 in the second group period 410 of the second row period 320 is obtained by shifting the activation time slots SWT2, SWT5, and the SWT8 in the second group period 410 of the first row period 310 in a right rotation manner. The same relationship occurs between activation time slots in the third group period 420 of the second row period 320 and those in the third group period 420 of the first row period 310.

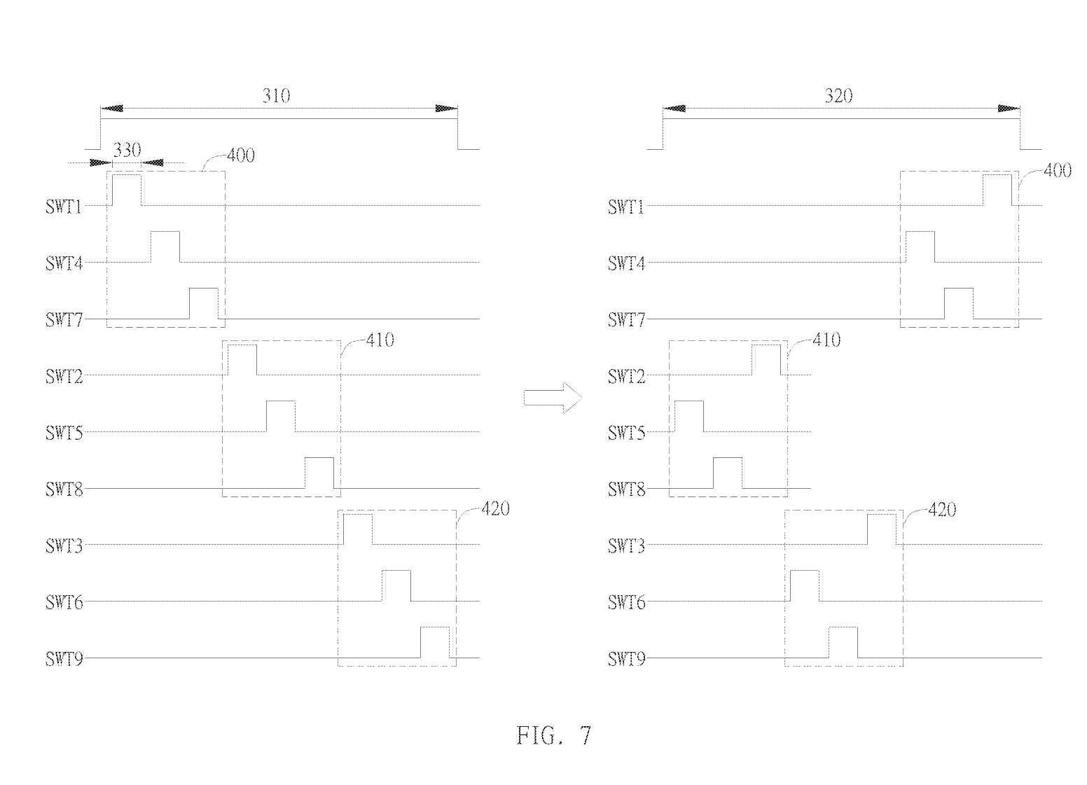

In the embodiment illustrated in FIG. 7, the order of the first group period 400, the second group period 410, and the third group period 420 in the first row period 310 is identical to that illustrated in FIG. 4B. In the present embodiment, the order of the first group period 400, the second group period 410, and the third group period 420 in the second row period 320 are obtained by shifting the first group period 400, the second group period 410, and the third group period 420 in the first row period 310 in a left rotation manner. However, the order of the activation time slots SWT1, SWT4, and SWT7 in the first group period 400 of the second row period 320 is obtained by also shifting the SWT1, SWT4, and SWT7 in the first group period 400 of the first row period 310 in a left rotation manner. The activation time slots in the second group period 410 and the third group period 430 of the second row period 320 are obtained by a similar rotation manner.

In the embodiments described above, data (voltages) stored in the storage capacitors in the pixel units R1, R2, R3, G1, G2, G3, B1, B2, and B3 in the second row 220 illustrated in FIG. 3 are updated during the second row period 320 or after data update is performed on the pixel units in the first row 210. However, in different embodiments, data stored in the storage capacitors in the pixel units of the third row 230 is updated during the second row period 220 or after data update is performed on the first row 210. In other words, data in the pixel units of the third row 230 can be updated immediately after data update on the pixel units of the first row 210 is completed.

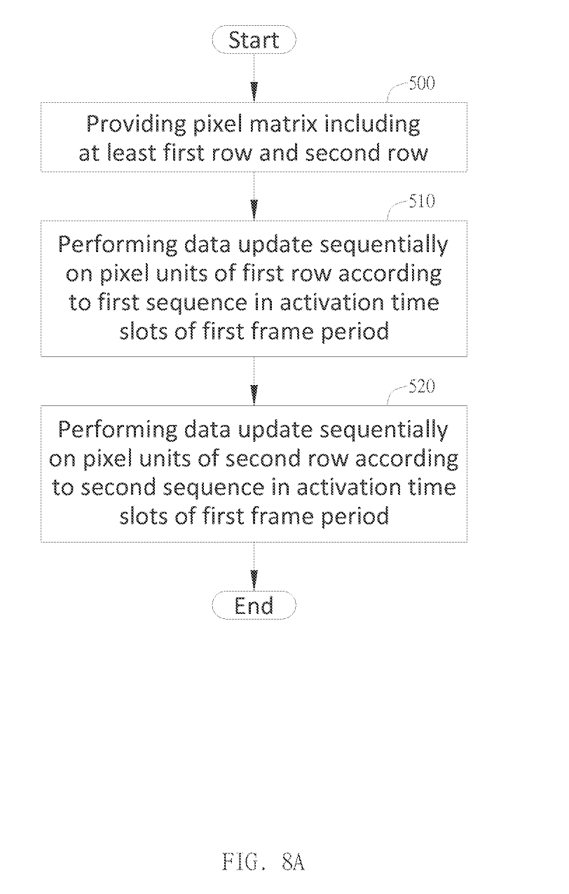

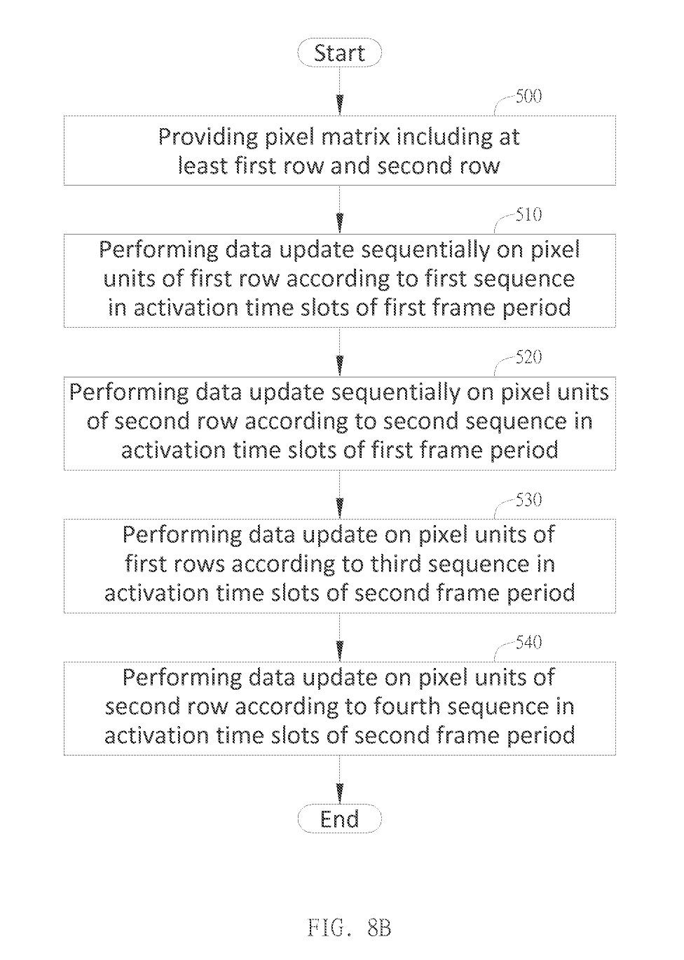

FIG. 8A is a flow chart illustrating the image optimization method of the present invention. The image optimization method includes step 500 of providing a pixel matrix which includes at least a first row and a second row. The first row and the second row respectively include a plurality of pixel units. Step 510 includes performing data update sequentially on pixel units of the first row according to a first sequence in a plurality of activation time slots of a first frame period. Step 520 includes performing data update sequentially on the pixel units of the second row according to a second sequence, wherein the second sequence is different from the first sequence. Furthermore, each data update is performed separately in a plurality of activation time slots within the first frame period.

Furthermore, as FIG. 8B shows, the image optimization method further includes step 530 of performing data update sequentially on the pixel units of the first row according to a third sequence in the activation time slots of the first frame period. Step 540 includes performing data update on the pixel units of the second row according to a fourth sequence in the activation time slots of a second frame period. In the embodiments illustrated in FIG. 8A and FIG. 8B, the sequences of data update on pixel units are different. The above-mentioned sequences are the orders according to which the data accepting switches of the corresponding pixel units are activated. The sequences of data update include those illustrated in FIG. 4B, FIG. 5, FIG. 6, and FIG. 7, but are not limited thereto; in different embodiments, the sequences can be adjusted to have other variations in accordance with requirements of the liquid crystal display device.

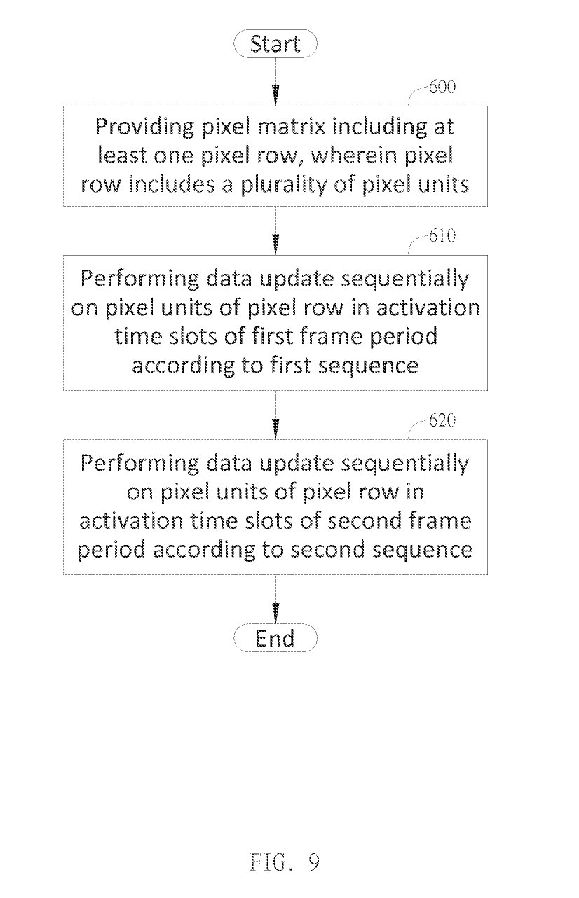

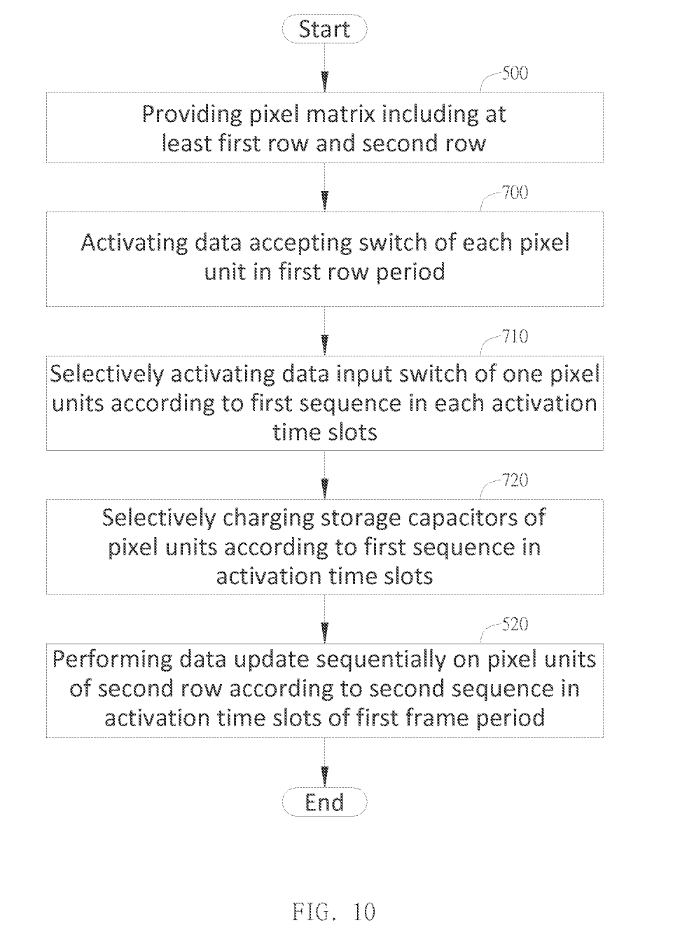

FIG. 9 illustrates yet another variation embodiment of the image optimization method illustrated in FIG. 8A. As FIG. 9 shows, the image optimization method includes step 600 of providing a pixel matrix which includes at least one pixel row. Step 610 includes performing data update sequentially on the pixel units of the pixel row according to a first sequence in a plurality of activation time slots of a first frame period. Step 620 includes performing data update sequentially on the pixel units of the pixel row according to a second sequence in a plurality of activation time slots of a second frame period. In the present embodiment, in the first frame period, the sequence of data update on every pixel row is the same. However, in the second frame period, the data update on every pixel row is performed in different sequence. The above-mentioned sequences are the orders according to which the data accepting switches of the pixel units are activated. The sequence of data update includes those illustrated in FIG. 4B, FIG. 5, FIG. 6, and FIG. 7, but are not limited thereto; in different embodiments, the sequences can be adjusted to have other variations in accordance with requirements of the liquid crystal display device.

FIG. 10 illustrates an embodiment of performing data update on the pixel units illustrated in FIG. 8A. The step of performing data update includes step 700 of activating a data accepting switch of each pixel unit in a first row period. The first row period is a time segment in the first frame period. Preferably, the data accepting switches of the pixel units in the first row are activated first, then those of the pixel units in the second row, but are not limited thereto. Alternatively, pixel units in the second row can be activated first, then the pixel units in the first row. Step 710 includes selectively activating a data input switch of one of the pixel units according to the first sequence in each of the activation time slots. Data input switch of a pixel unit must be activated for the storage capacitor of the corresponding pixel unit to be charged. The first sequence decides the order according to which the data input switches are activated. Order of the first sequence may vary from the first frame period to a second frame period and thus the order according to which data accepting switches can also vary. Step 720 includes selectively charging storage capacitors of the pixel units according to the first sequence in the activation time slots. In the present embodiment, step 720 is performed after every data input switch of the pixel unit is activated, but is not limited thereto. In different embodiment, the storage capacitor can be charged right after the data input switch of the corresponding pixel unit is activated. In the present embodiment, relative position between the first frame period and the first row period is variable. In other words, the timing of activating the data input switches of the pixel units can vary during the first frame period.

The above is a detailed description of the particular embodiment of the invention which is not intended to limit the invention to the embodiment described. It is recognized that modifications within the scope of the invention will occur to a person skilled in the art. Such modifications and equivalents of the invention are intended for inclusion within the scope of this invention.

What is claimed is:

1. An image optimization method of a liquid crystal display device, comprising: providing a pixel matrix including at least a first row and a second row, wherein
each of the first row and the second row includes a plurality of pixel units; performing data update sequentially on the pixel units of the first row according to
a first sequence in a plurality of activation time slots of a first frame period; performing data update sequentially on the pixel units of the second row
according to a second sequence in the plurality of activation time slots of the first frame period;
wherein the first sequence is different from the second sequence.

2. The image optimization method of claim 1, wherein the first sequence and the second sequence are in mutually reverse order.

3. The image optimization method of claim 1, wherein the pixel matrix further includes a third row disposed between the first row and the second row, the third row includes a plurality of pixel units.

4. The image optimization method of claim 3, further comprising performing data update sequentially on the pixel units of the third row according to a third sequence in the activation time slots of the first frame period, wherein the third sequence is different from the second sequence.

5. The image optimization method of claim 1, wherein the second sequence is obtained by shifting the first sequence by at least one activation time slot.

6. The image optimization method of claim 1, further comprising:
performing data update on the pixel units of the first rows according to a third sequence in a plurality of activation time slots of a second frame period; and
performing data update on the pixel units of the second row according to a fourth sequence in the plurality of activation time slots of the second frame period;
wherein the third sequence is different from the fourth sequence, the third sequence corresponds to the first sequence while the fourth sequence corresponds to the second sequence.

7. The image optimization method of claim 6, wherein the first sequence and the third sequence are in mutually reverse order, the second sequence and the fourth sequence are in mutually reverse order.

8. The image optimization method of claim 6, wherein the third sequence is obtained by shifting the first sequence by at least one activation time slot, the fourth sequence is obtained by shifting the second sequence by at least one activation time slot.

9. The image optimization method of claim 1, wherein each of the pixel units has a corresponding pixel color.

10. The image optimization method of claim 9, wherein data update is performed sequentially on the pixel units having same pixel color.

11. The image optimization method of claim 9, further comprising a step of grouping the pixel units into at least a first color group and a second color group, wherein the first row and the second row respectively has at least one first color group and at least one second color group, the first color group and the second color group respectively has a plurality of pixel units having same pixel color.

12. The image optimization method of claim 11, further comprising a step of performing data update separately on the pixel units of the first color group and of the second color group.

13. The image optimization method of claim 11, wherein a sequence of data update performed on the first color group is different to a sequence of data update performed on the second color group.

14. The image optimization method of claim 9, further comprising a step of classifying the pixel units into at least one first sub-pixel and at least one second sub-pixel, the first sub-pixel and the second sub-pixel have a first color and a second color, respectively.

15. The image optimization method of claim 14, further comprising:
disposing the first sub-pixels and the second sub-pixels alternatively on the first row; and
disposing the first sub-pixels and the second sub-pixels alternatively on the second row;
wherein positions of the first sub-pixels of the first row and positions of the second sub-pixels of the first row correspond to positions of the first sub-pixels of the second row and positions of the second sub-pixels of the second row, respectively.

16. The image optimization method of claim 15, further comprising a step of performing data update separately on the first sub-pixels and the second sub-pixels.

17. The image optimization method of claim 9, further comprising a step of classifying the pixel units into a plurality of main pixels, wherein each of the main pixels includes pixel units having different pixel colors.

18. The image optimization method of claim 9, wherein the step of performing data update on the pixel units of the first row includes:
activating a data accepting switch of each pixel unit in a first row period;
selectively activating a data input switch of one of the pixel units according to the first sequence in each of the activation time slots; and
selectively charging storage capacitors of the pixel units according to the first sequence in the activation time slots;
wherein a relative position between the first frame period and the first row period is variable.

19. An image optimization method of a liquid crystal display device, comprising:
providing a pixel matrix including at least one pixel row, wherein the pixel row includes a plurality of pixel units;
performing data update sequentially on the pixel units of the pixel row in a plurality of activation time slots of a first frame period according to a first sequence; and
performing data update sequentially on the pixel units of the pixel row in a plurality of activation time slots of a second frame period according to a second sequence;
wherein the first sequence is different from the second sequence.
